(19) United States
(12) Patent Application Publication
(10) Pub. No.: US 2017/0042116 A1
(43) Pub. Date: Feb. 16, 2017

(54) FOOD DISPENSER AND METHOD OF USING IT

(71) Applicant: NORTHMATE APS, Odense SØ (DK)

(72) Inventors: Frederik Estrup Lindskov, Tikøb (DK); Mikkel Hansen, København V (DK)

(73) Assignee: NORTHMATE APS, Odense SO (DK)

(21) Appl. No.: 15/307,638

(22) PCT Filed: Apr. 29, 2014
(86) PCT No.: PCT/IB2014/061076

§ 371 Date: Oct. 28, 2016

(51) Int. Cl. A01K 5/01; A01K 5/02; A01K 15/02

(52) U.S. Cl. CPC A01K 5/0114; A01K 15/02; A01K 5/0225

(57) ABSTRACT

A method of exercising and/or training an animal by providing a plurality of food dispensers charged with one or more food items, including a first food dispenser and at least one second food dispenser, with each food dispenser including a feeding bowl having certain features and wherein the plurality of food dispensers has respective control units programmed to link the plurality of food dispensers to each other in a predetermined execution pattern mode. The method includes providing a signal from the signaling means to the animal to indicate that food may be dispensed from the food dispenser and to guide the animal to the first food dispenser, wherein the signal causes the animal to actuate the manipulation end of the actuator to cause the rotary mechanism to dispense at least one food item via the outlet opening.

The present invention relates to a food dispenser of the kind comprising
a base plate,
a feeding bowl with a plurality of food compartments,
a rotary mechanism for rotating the feeding bowl in relation to the base plate, and
a lid that covers at least the majority of the food compartments and has an outlet opening.

US patent application no. 2005/066905 relates to an automated pet feeder of the above kind. The pet feeder comprises a rotatable bowl with multiple cavities to hold food for different meals; a lid that covers said cavities; wherein said lid comprises an opening that exposes one cavity; a base unit configured to support said rotatable bowl and said lid; a rotary mechanism for rotating said rotatable bowl relative to said base unit, while said lid remains stationary relative to said base unit. A timer is configured to provide an indication of a next feeding time. A control unit is configured to receive the indication from the timer, and based on the indication to trigger said rotary mechanism to rotate the bowl. The rotation serves to position a next one of the cavities of the rotatable bowl under the dispensing opening of the lid to dispense food stored in said cavity.

This known device has the disadvantage that predetermined amounts of food are dispensed on predetermined times, such as eight, twelve, or twenty-four hours, following a predetermined feeding schedule. So if the animal to be fed is not hungry the food may stay exposed for long time, or the animal may just eat because the food is available and then become fatter and fatter. A further disadvantage is that the pet feeder has no interaction or interplay with the animal to be fed.

Thus there is a need within the art of feeding animals for alternative feeding apparatuses and feeding methods.

In a first aspect according to the present invention is provided a food dispenser of the kind mentioned in the opening paragraph wherein dispensing requires interaction by the animal.

In a second aspect according to the present invention is provided a food dispenser of the kind mentioned in the opening paragraph the use of which exercises and mentally stimulates the animal.

In a third aspect according to the present invention is provided a food dispenser of the kind mentioned in the opening paragraph in an exercising and/or training method.

In a fourth aspect according to the present invention is provided a food dispenser of the kind mentioned in the opening paragraph in a method that keeps the attention of the animal occupied.

The novel and unique whereby these and other aspects are achieved by the present invention consists in that the food dispenser comprises that
the lid comprises a first lid part in form of an outer annular skirt detachable connected to the base plate and defining a central charging opening,
a second lid part for detachably covering the charging opening,
an actuator having a free manipulation end in operative contact with the second lid part, which actuator upon actuation activates at least the rotary mechanism to rotate the feeding bowl to place a food compartment in front of the outlet opening of the first lid part.

Commercial pet foods are designed in view of balancing the protein, carbohydrates, fats, vitamins and minerals for nutrition of the pet to live a long and healthy life, but often the pet is fed wrongly or is overfed simply because the food is available.

Not only composition, amount, and accessibility of food are important issues to the pet. Also exercise is important for maintaining healthy muscles, bones and joints in pets, such as dogs and cats. Dogs and other pets getting daily exercise tend to look good, feel good and live longer. Exercise, such as walking the dog or playing with the dog, is mentally stimulating and helps work off excess energy so that the dog can act more quietly afterwards. Walking, training and playing the dog is however often time-consuming and many dog owners never exercise their dog enough due to lack of time.

Animals, such as dogs or cats, love to learn something new and to search, find and play with things. They will be encouraged by the smell of the food to seek for the food dispenser, which dispenser can be placed on different locations to offer and deliver sized portions of food to the animal. To get a portion of food out of the food dispenser the animal pushes, e.g. using a paw or the snout, on the free manipulation end of the second lid part, or just on the second lid part, so that the rotary mechanism rotates the feeding bowl to place a food compartment in front of the outlet opening of the first lid part to dispense the portion of food from said aligned food compartment. The animal may be lucky to activate the actuator in a first attempt, but sometimes the animal may need several attempts before the animal has applied a force sufficient to activate the actuator, and/or it is able to hit on the actuator appropriately. The animal can smell the food inside the food compartments, or the animal just know that the food is stored inside the food compartments, and eventually an animal will often learn itself by trying over and over again to operate the actuator to be rewarded with food.

So the food dispenser according to the present invention is not simply a food dispenser. It requires interaction by the animal resulting also in mental stimulation. Animals such as dogs and cats benefit from this kinds of new learning experience and from the challenge of getting food out of the food dispenser by activation of the actuator. Once the animal gets acquainted with the dispensing procedure, animals, such as dogs, will have fun doing the repetition to get more food from the food dispenser.

A bottom face of the base plate may have a receptacle for accommodating at least a motor unit of the rotary mechanism, thereby protecting the motor unit from being damaged when the animal pushes on food dispenser, and thus also from being contaminated with food residues and animals secretions.

A control unit serves to control the operation of the food dispenser, including controlling the angle the rotary mechanism rotates the feeding bowl, when the rotation takes place, so that a food compartment becomes correctly positioned aligned with the outlet opening. Preferably, the control unit can be positioned in the receptacle as well.

The control unit may further comprise at least
a signaling means that comprises one or more of a system for emitting an audible signal and a system for emitting a visual signal, and/or
a microprocessor or a microcontroller with a software program to be executed for running the food dispenser in a stand-alone mode or for running the food dispenser in a linked mode in a system operationally linked to several other food dispensers.

The signaling means can thus issue either an audible or a visual signal to attract the animal's attention to the respective food dispenser related to said signaling means, thereby enabling the animal to locate the actual food dispenser wherefrom foods can be dispensed. This is particular relevant in case the food dispenser is used in a method involving more than one food dispenser, however the signaling means are also important to alert the animal that food is served.

The microprocessor or microcontroller is a conventional electric component serving the function of a small computer for executing a software program configured to run the food dispenser in various modes, thus the software is uniquely designed for operation of one food dispenser alone or for several food dispenser in wireless communication.

The system for emitting an audible signal may advantageously produce ultrasound, preferably at a frequency of at least 20 kHz. Dogs hear higher frequency sounds than humans. Typically dogs hear frequencies in the interval from 67 Hz to 44 kHz, and cats hear frequencies in the interval from 55 Hz up to 79 kHz, whereas humans hear frequencies in the more narrow interval from 31 Hz up to 18 kHz. Thus by selecting ultrasound frequencies the audible signal becomes audible to animals but not humans, thereby avoiding noise inconveniences to humans during use.

The control unit of the food dispenser may comprise a wireless communication means, which wireless communication means includes at least one transmitter and at least one receiver, preferably a transceiver, to enable electronic communication from one food dispenser to another, and between food dispensers.

So the wireless communication means of a first food dispenser may be adapted for wireless communication with a wireless communication means of at least one second food dispenser, and vice versa. Said food dispenser may then be placed in radio distance from each other, so that transmittal of a signal from a transmitter to a receiver triggers at least the signaling means. As an example, after a portion of food has been dispensed from a food compartment of a first food dispenser, a transmitter of the first food dispenser sends a wireless signal to another food dispenser known by the control system of the first food dispenser. This wireless signal is received by a receiver of the other food dispenser, and in response to reception of the wireless signal the signaling means of the other food dispenser issues a visual or audible signal that attract the animal attention and guides the animal in the direction towards the other food dispenser to collect a further food portion from this other food dispenser. This process can be repeated again starting from the other food dispenser communicating a wireless signal to the first food dispenser or to yet another food dispenser.

Further, the actuator may be operable to activate at least the transmitter and/or the rotary mechanism. So activation of the actuator may trigger the signaling means, preferably after a predetermined delay selected appropriately to allow the animal to consume the food portion prior to having to run to the other food dispenser to get more food.

The feeding bowl may include
a tapering main body having a feeding bowl base and a central opening in axial distance from the feeding bowl base,
the feeding bowl base has a larger diameter than the diameter of the central opening, and
the tapering body has an interior part configured to engage the rotary mechanism, and an exterior part configured with a plurality of annular spaced apart partition wall for delimiting the plurality of food compartments.

By providing the feeding bowl with an overall tapering shape, e.g. as a cone or a frustocone, the food can easily be charged to the food compartments via the central charging opening, and will move along the inclined upper face of the feeding bowl towards the inner face of the first lid part simply under the influence of gravity. When a food compartment is moved by rotation to the outlet opening the food is brought along by the partition walls, and optionally by the inner face of the first lid part, for, at the end of a rotation step, being discharged via the outlet opening, also simply under the influence of gravity, although the animal may tend to take active part in moving a food portion out of a respective food compartment by scratching with a paw, pushing with the snout, or licking the thong.

In a preferred embodiment the feeding bowl may have seven annularly spaced feed compartments separated by seven partition walls.

To facilitate and expedite dispensing of a food portion a food compartment may be configured as a chute, optionally the food compartment also has a plurality of guide grooves diverging in fan-shape from the central opening towards the feeding bowl base.

The actuator may be a spring-biased elongated body having at least a manipulation end positioned in and/or extending through the central opening of the tapering body of the feeding bowl so as to be accessible for the animal from outside the food dispenser either directly or due to the manipulation end being connected to the second lid part. The spring serves to reciprocate the actuator after actuation, thus after the animal has pressed the actuator axially towards the base plate for activating the motor unit of the rotary mechanism.

The base plate may have a lower portion extending radially via a circumferential waste groove into an upright rim portion surrounding the feeding bowl base of the feeding bowl to prevent dispensed food from falling out of the food dispenser. The circumferential waste groove may also serve to collect non-eaten residues of dispensed food.

To keep any foreign matter away from the components inside the receptacle of the base plate, and to protect these components from getting damaged by the animal, including being damaged due to mechanical and chemical actions, the food dispenser may comprise a cover part for said receptacle, preferably a detachable cover part.

The cover part may expediently be designed to accommodate at least one or more of a power supply, a first on/off switch for the power supply, a second on/off switch for the wire less communication system, a third on/off switch for the signaling means, and a speaker outlet. Any of the first on/off switch, the second on/off switch and the third on/off switch may be adapted to switch on more than one function. Thus the on/off switch for the power supply may e.g. also switch on/off the signaling means as well as the wire less communication system. However, should it be preferred to use the food dispenser without the wireless communication system as a stand-alone unit, it may be preferred to provide more or less distinct switches. In the present context the term “cover part” or “cover part is designed to accommodate” means that the cover part has an opening or a cavity for making a switch or power supply accessible to be operated from outside the food dispenser. The power supply can e.g. be batteries stored in a battery chamber of the cover part and being in electric communication with the electronic components, including but not limited to electronic components on a printed circuit, inside the receptacle of the base plate. A switch may protrude from the receptacle via an opening in the cover part to switch on/off a contact located inside the receptacle. Further, the cover part may be provided with monitoring windows and/or light indicators to enable the user to establish that the food dispenser is turned on and in operative mode.

The first lid part may have a peripheral first engagement means along a free bottom edge, and the base plate may have a peripheral second engagement means for engaging the first engagement means, thereby making the first lid part disengagable from the base plate to facilitate cleaning and replace a damaged first lid part, or just replacing a lid part not to the liking of the user.

The peripheral second engagement means is located in the circumferential waste groove or in the upright rim portion of the base plate, or in both, so that rotation of the feeding bowl can take place unobstructed.

Exemplary engagement means include but are not limited to peripheral first engagement means being a plurality of annularly spaced apart webs protruding towards the base plate, and peripheral second engagement means being holes or slots dimensioned to interlock and/or engage the peripheral first engagement means.

Anti-sliding means provided on the bottom face of the base plate may prevent the animal from easily pushing the food dispenser around when actuation of the rotary mechanism takes place. A suitable anti-sliding means is e.g. rubber pads or other frictional means adhered to the bottom face of the base plate.

To rotate the feeding bowl in response to activation of the actuator the rotary mechanism may comprise a synchronization ring inserted between the feeding bowl and the base plate, which synchronization ring can have
an upper engagement face with a third engagement means to interlock and/or engage fourth engagement means on the interior part of the tapering body of the feeding bowl, and
a lower drive face provided with a first drive means for engaging a second drive means associated with the base plate.

The second drive means may be located at least partly inside the receptacle of the base plate and have a coupling part protruding radially outwards via an opening in the base plate to engage the first drive means.

For simple engagement the first drive means and/or the second drive means can be toothed drives and/or gear wheels, such as the first drive means being a tooth belt and the second drive means comprising a tooth disk on a rotary shaft of the motor unit. Alternative suitable gearings may be used instead.

In one embodiment the base plate advantageously extends into a central upright connection piece for internally receiving an inner part of the actuator, which inner part has a length that reaches inside the receptacle to activate at least a first contact for the rotary mechanism, and optionally also a second contact for the signaling means, upon activation by depression of the actuator towards the receptacle. An actuator head extends outside the feeding bowl serving as a push button at the manipulation end. The inner part of the actuator is preferably a hollow elongated tubular part, or a number of rods extending from the actuator head towards a corresponding number of contacts located in the receptacle. Externally the central upright connection piece provides a mount for at least the synchronization ring, the feeding bowl and the second lid part.

In order that the visual signal from the system for emitting a visual signal can be seen from outside the food dispenser, the central upright connection piece may terminate in a screen, shade or cover that permits seeing light emitted by an LED or bulb located inside the receptacle along the same longitudinal axis as the inner part of the actuator, or located parallel to said longitudinal axis. If the inner part of the actuator is hollow the first and second contacts are preferably located below the wall of the inner part. In the alternative the inner part can be elongated circumferentially spaced apart webs or rod in extension of the actuator head.

Accordingly, the actuator end of the actuator opposite the free manipulation end is in operative contact with components of any of the control unit or the rotary mechanism.

In an embodiment particularly suited for a stand-alone mode, although not limited thereto, the control unit may comprise a timer for activating the rotary mechanism to rotate the feeding bowl to place a food compartment in front of the outlet opening of the first lid part to dispense a food item in case the actuator has not been mechanically activated for a predetermined period.

The invention also relates to a method of exercising and/or training an animal.

The method comprises the steps of
a) providing a plurality of food dispensers charged with one or more food items, which plurality comprises a first food dispenser and at least one second food dispenser according to any of the preceding claims, in wireless communication distance from each other, which plurality of food dispensers has respective control units programmed to link the plurality of food dispensers to each other in a predetermined execution pattern mode,
b) switching on the power, the wireless communication system, and the signaling means of the food dispensers of the plurality of food dispensers,
c) starting the first food dispenser of the plurality of food dispensers,
d) the signaling means of the first food dispenser of the plurality of food dispensers issues a signal to the animal guiding the animal to the first food dispenser,
e) said signal causes the animal to actuate the manipulation end of the actuator to operate the rotary mechanism to rotate the feeding bowl an angle of 360°/n, wherein n is the number of food compartments, to dispense at least one food item via the outlet opening,
f) subsequent to the dispensing of step f) the wireless communication system activates the signaling means of the next food dispenser of the plurality of food dispensers to issue a same or different signal to the animal guiding the animal to said next food dispenser, and
g) repeating steps e)-f).

The animal may continue eating from different food dispensers following a schedule determined by choosing from a selection of schedules configured by a computer program of the control unit.

The feeding bowl of a food dispenser of the plurality of food dispensers can be rotated maximum n−1 angular steps before the food dispenser is empty. It is obvious that at the start of the method of exercising and/or training an animal, or other initial use of the food dispenser according to the present invention, the first compartment in front of the outlet opening is always empty because there are nothing that prevents the food from falling out.

In a preferred embodiment of the method the number of food dispensers in a plurality of food dispensers is at least two to force the animal to move between these two food dispensers to satisfy it's hunger, and at the same time getting inherent training, exercise and mental stimulation. The animal will experience the alternate dispensing of food portions as a fun game or play, and gradually be better and better to perform the method.

The food dispensers can be moved around as desired as long as maintenance of the wireless communication between the two food dispenser to be used in series are observed and secured. By moving the plurality of food dispensers around within wireless communication distance from time to time the animal can be subjected to new challenges over and over again.

It has been decided that in an expedient embodiment the number of food dispensers in a plurality of food dispensers as a maximum is equal to or less than fifty. There is however no upper limit for the number of food dispensers that can be used in the method according to the present invention, so e.g. thousand or even more is just a matter of programming, and manpower for charging each food dispenser with food, placing them at appropriate distances and starting them all.

The plurality of food dispensers can be operated in random order or sequentially. This is a matter of programming the control unit appropriately. So for optimum performance the microprocessor or microcontroller of the control unit is programmed with special software programs providing various training schedules and patterns. Alternatively, operation of the plurality of food dispensers follows a simple routine wherein actuation of one food dispenser is recognized by the next food dispenser, and once the rotating mechanism has rotated n−1 times the food dispenser enters a sleeping mode, where it becomes inactive.

The plurality of food dispensers may comprise at least one food dispenser not being in wireless communication with the remaining food dispensers to create yet a further challenge to the animal.

The control units detect automatically a pattern or arrangement of the plurality of food dispensers in accordance with instructions of the computer program code, and/or by transmitting wireless signals to be received by another food dispenser, that transmit a reply indicating to the food dispenser that issued the signal that the other food dispenser has been located and is ready to dispense. Thus a control unit of a first food dispenser tracks the nearest other food dispenser or the next food dispenser of the plurality as defined by the computer program, and this procedure is repeated every time a food dispenser has been activated. Emphasis is added that repetition includes that an already used food dispenser becomes the next food dispenser for a number of times until it is empty.

According to the present invention a method of feeding an animal comprises
providing a food dispenser charged with one or more food items,
wherein the food dispenser is programmed to set at least one time slot wherein the food dispenser is active for feeding the animal.

So food dispenser can also operate as a single unit game. In this situation the animal only have one available food dispenser to start the method, thus the game. This might happen is there only is one food dispenser, others are in purpose of being charged with food or are turned off, or others are already in another game mode. If this is the situation the active food dispenser unit can go into “single unit game mode”.

A food dispenser can be programmed to have a time frame from 1-10 hours, wherein the food dispenser generate a number, e.g. six, random time slots, where the unit is activated for feeding the animal. The food dispenser may be activated/re-activated immediately after each touch of the actuator if no time frame or time slot is chosen.

Further one or more food dispensers may be programmed to have at least one random set or fixed set time slot. Food dispenser already available may work on fixed set time slots.

The invention will now be described in further details by way of the drawing showing exemplary embodiments and components of these exemplary embodiments.

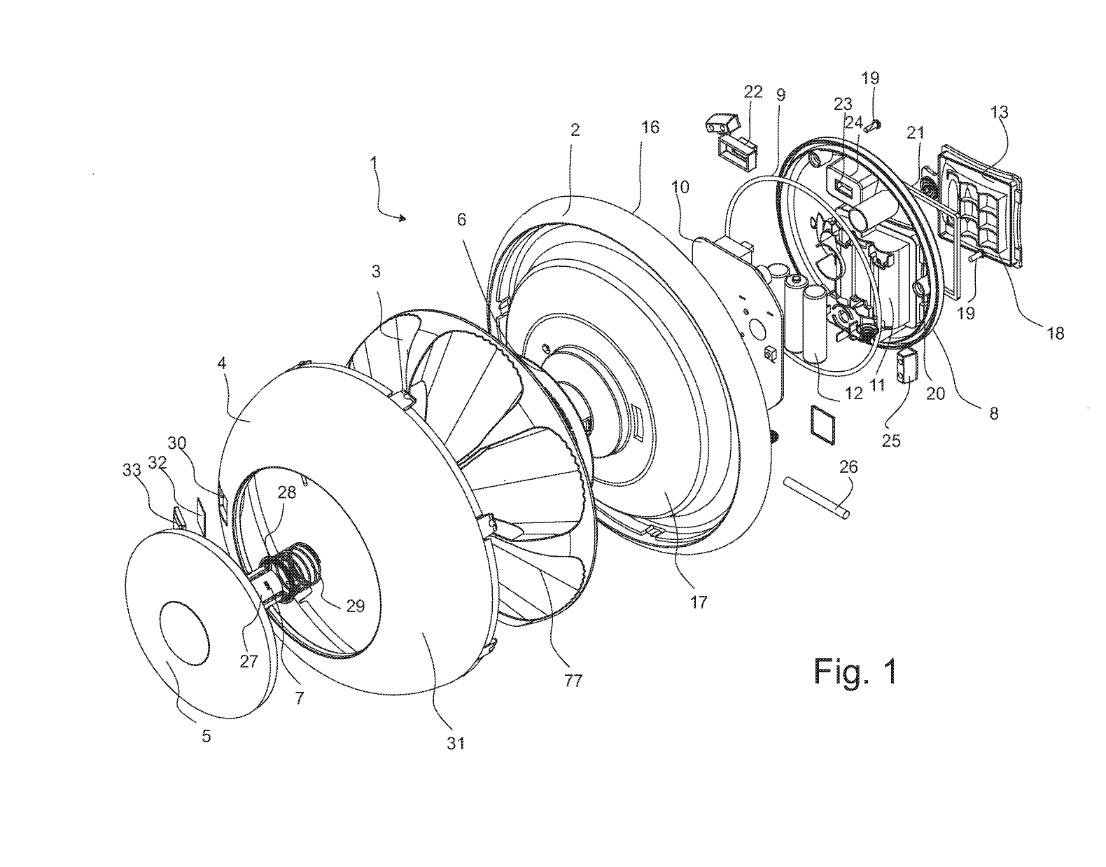

FIG. 1 is an exploded, perspective view of the main components of an embodiment of a food dispenser seen from the actuator end,

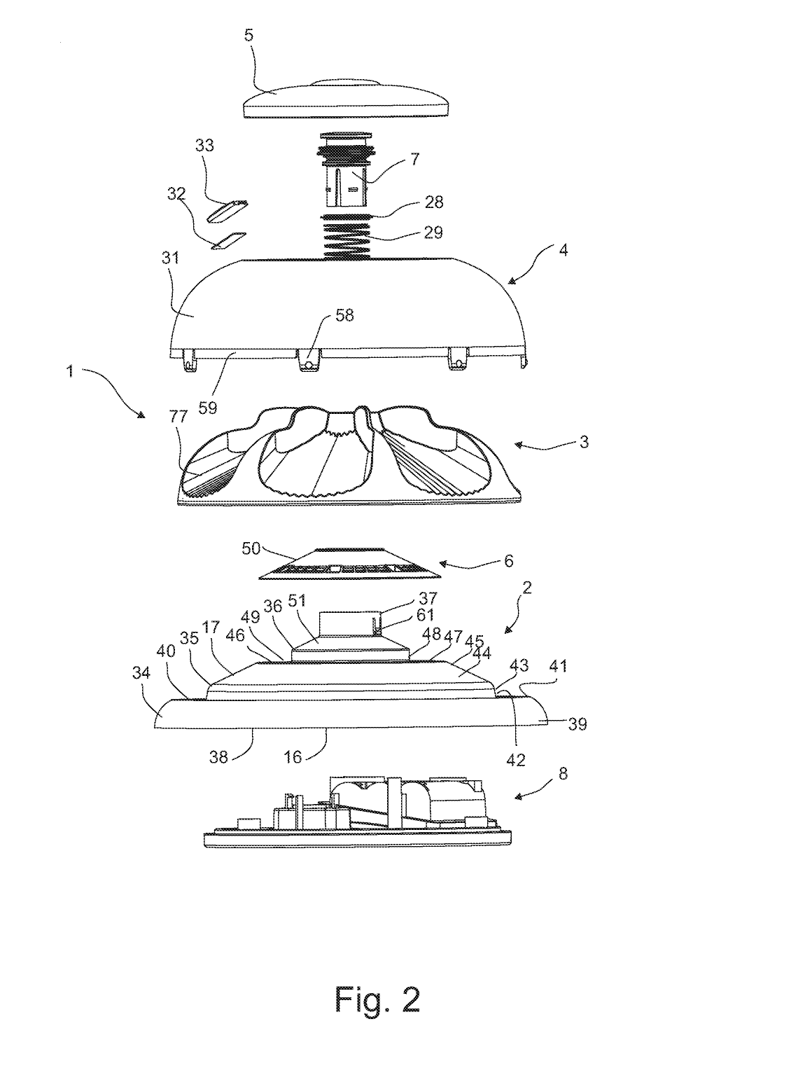

FIG. 2 shows the same in an exploded side view of the main components of an embodiment of a food dispenser without electronics, and

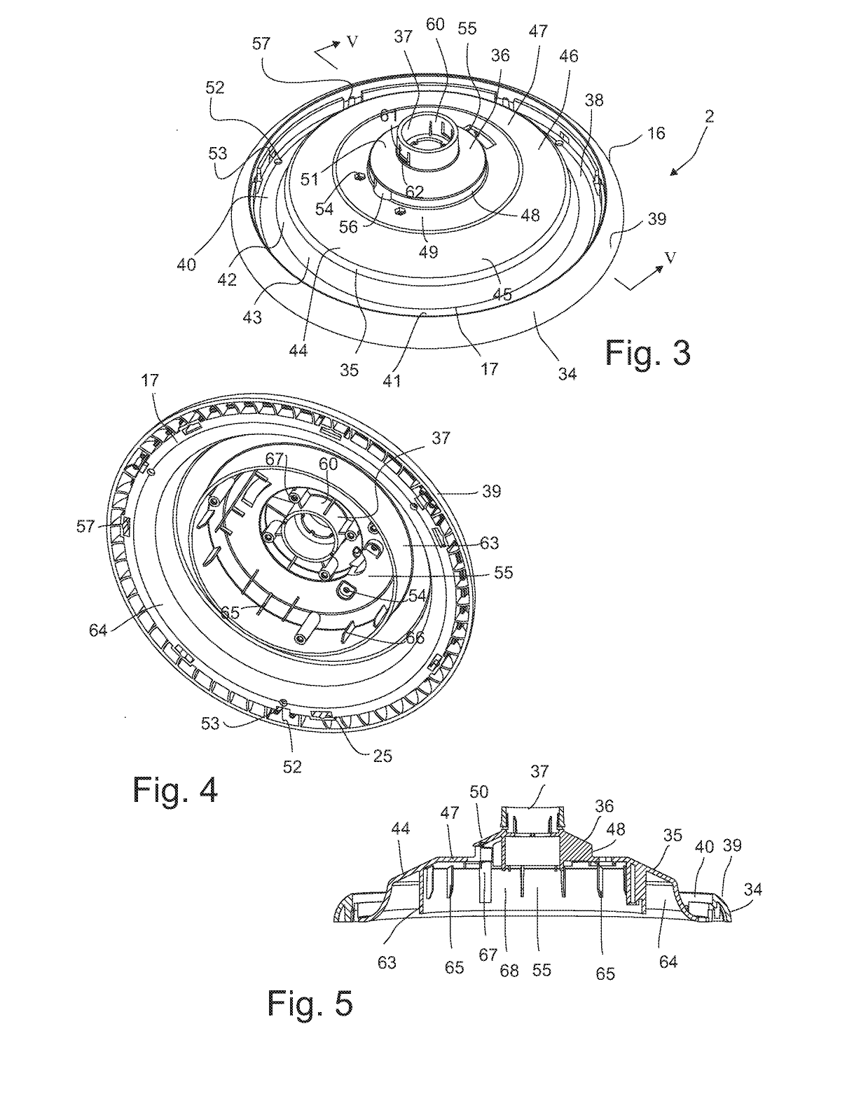

FIG. 3 is a perspective view of the base plate oblique from the top,

FIG. 4 shows the same oblique from below,

FIG. 5 is a sectional view taken along line V-V in FIG. 3,

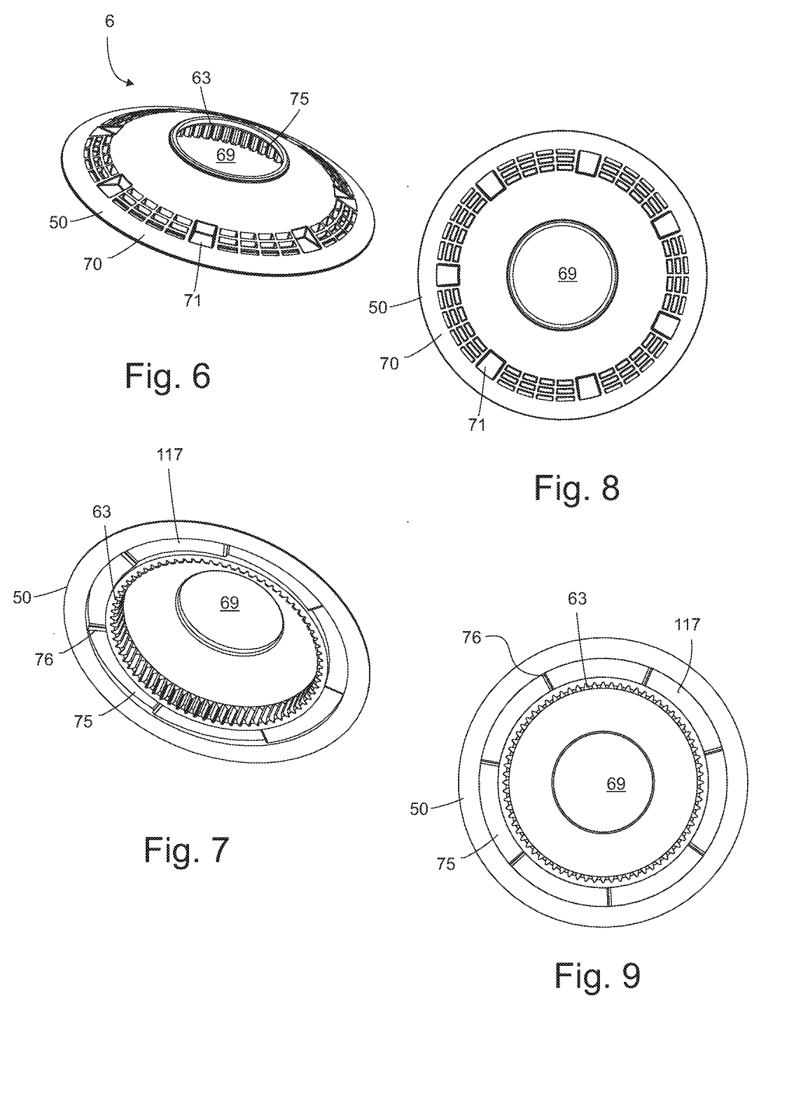

FIG. 6 is a perspective view of the synchronization ring of the rotary mechanism oblique from the top,

FIG. 7 shows the same oblique from below,

FIG. 8 is a top view of the same,

FIG. 9 is a bottom view of the same,

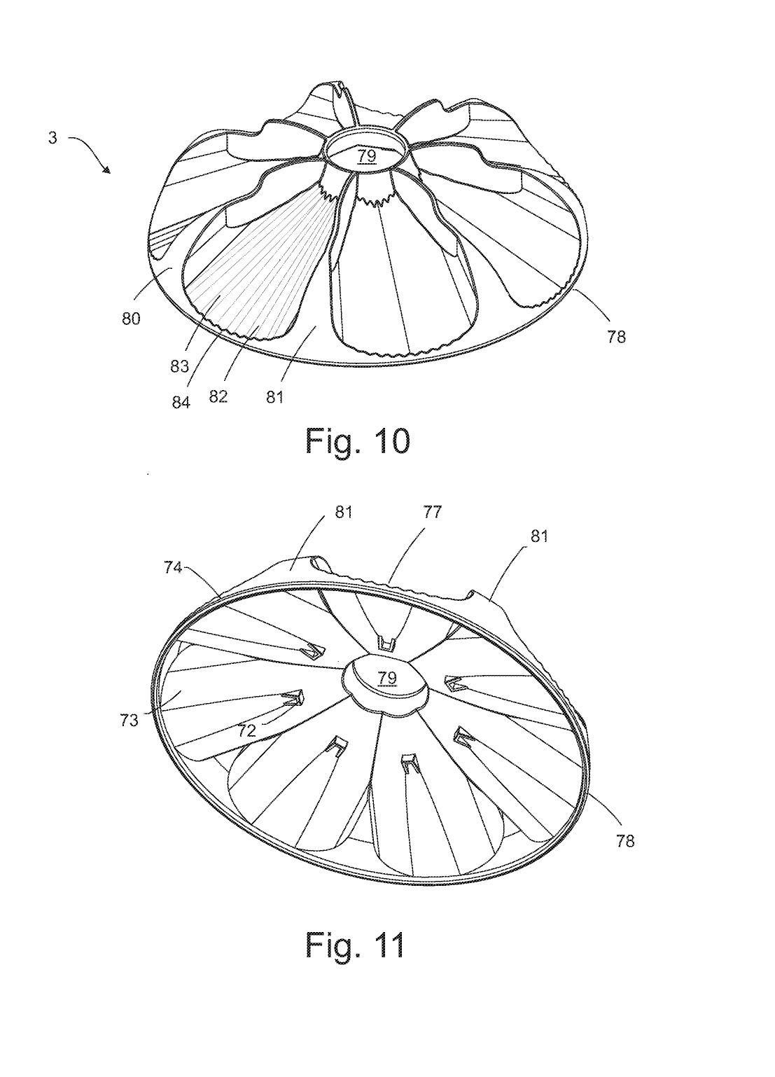

FIG. 10 is a perspective view of the feeding bowl oblique from the top,

FIG. 11 shows the same oblique from below,

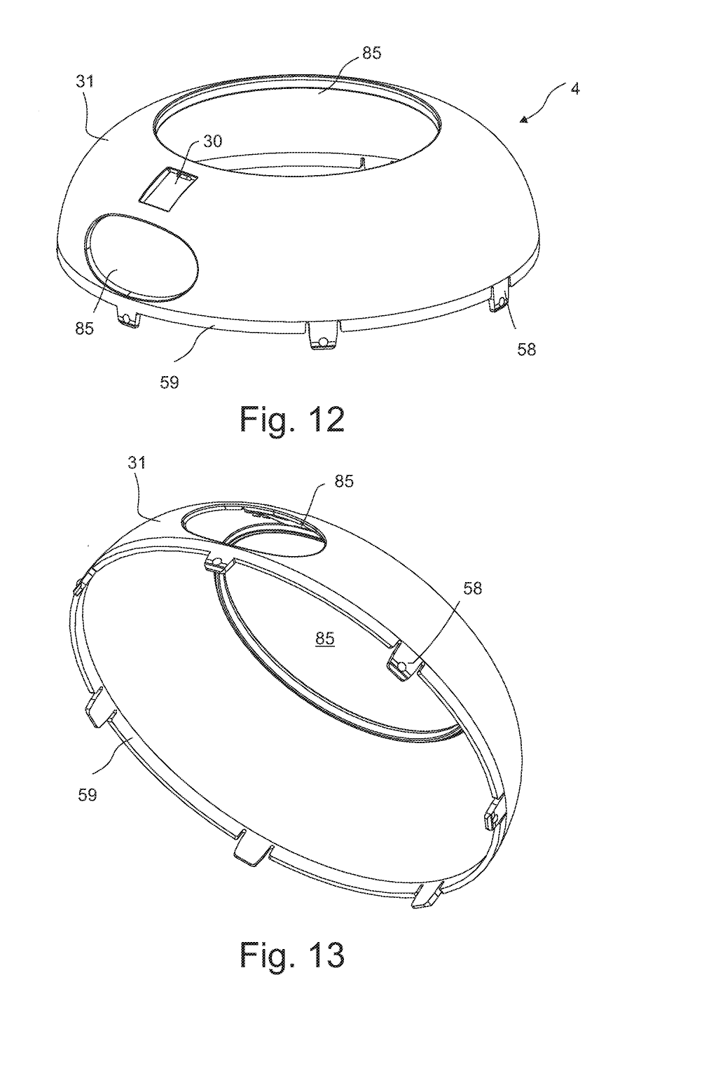

FIG. 12 is a perspective view of the first lid part oblique from the top,

FIG. 13 shows the same oblique from below,

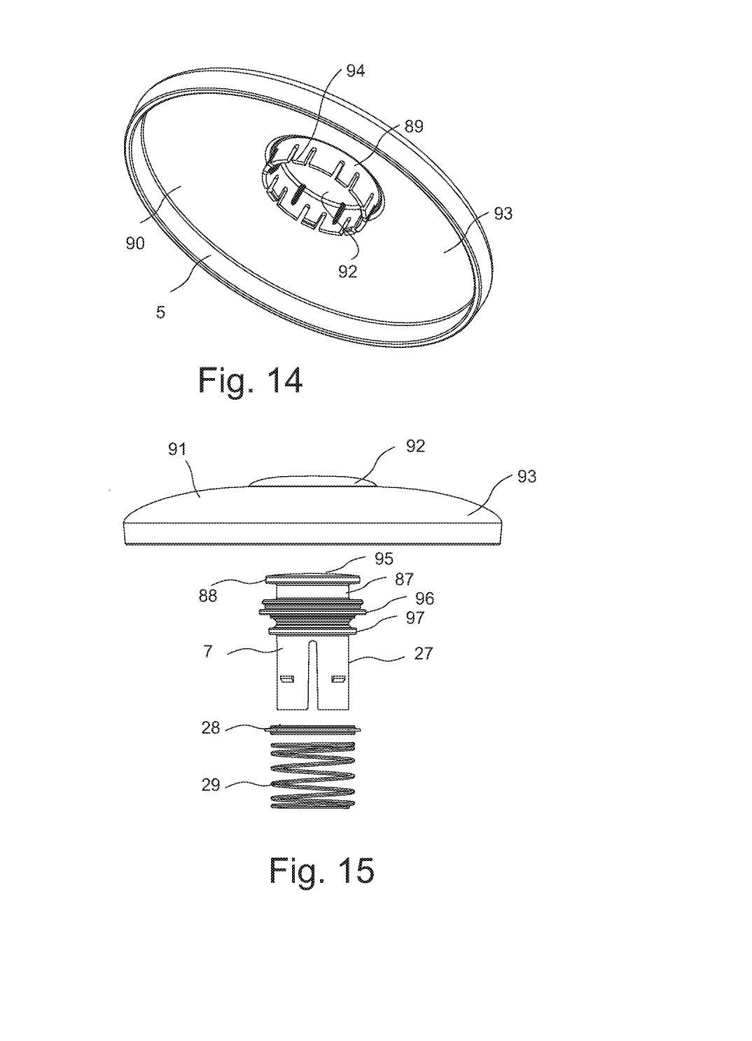

FIG. 14 is a perspective view of the second lid part oblique from below,

FIG. 15 is a side view of aligned actuator and second lid part,

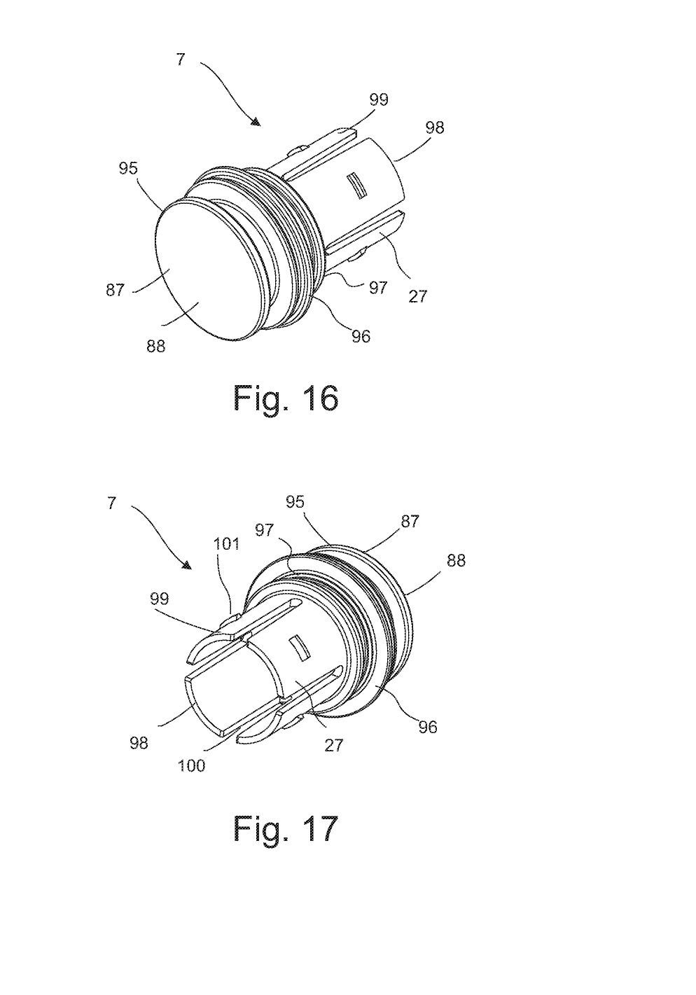

FIG. 16 is a perspective, enlarged scale view of the actuator seen from the manipulation end,

FIG. 17 shows the same seen from the opposite end,

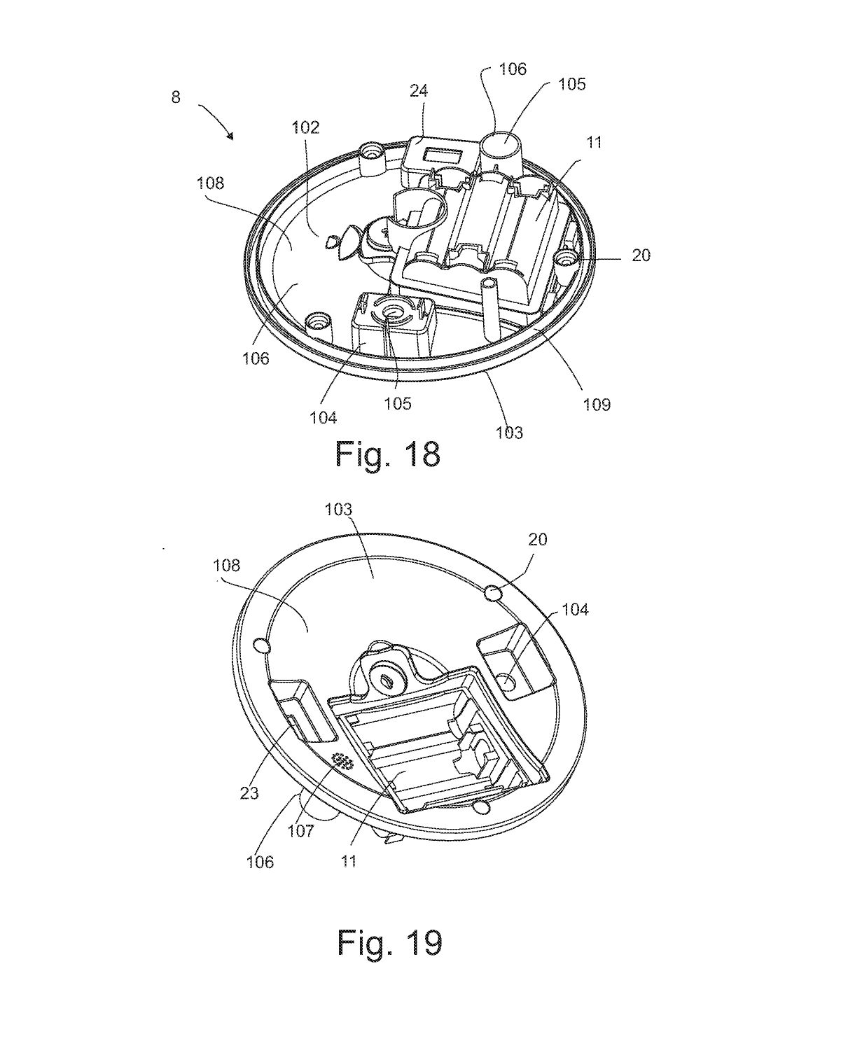

FIG. 18 is a perspective view of the cover part oblique from above,

FIG. 19 shows the same oblique from below,

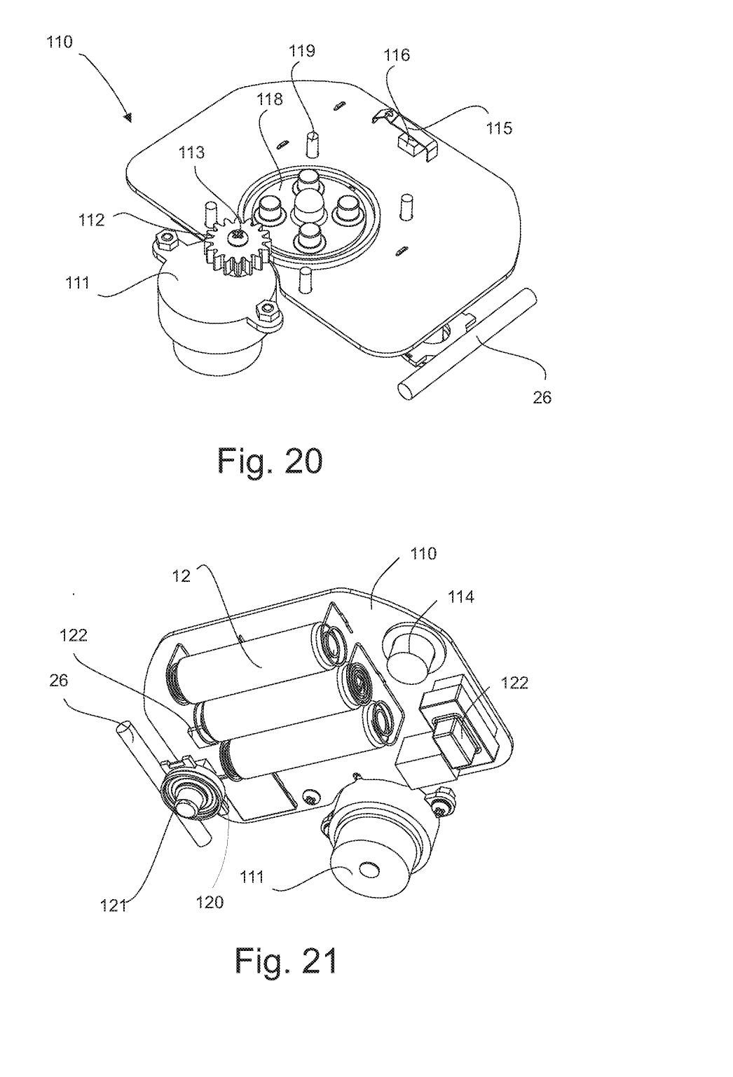

FIG. 20 is a perspective view seen oblique from above of a PCB with a motor unit, signaling means, and means for wireless communication,

FIG. 21 shows the same oblique from below with batteries,

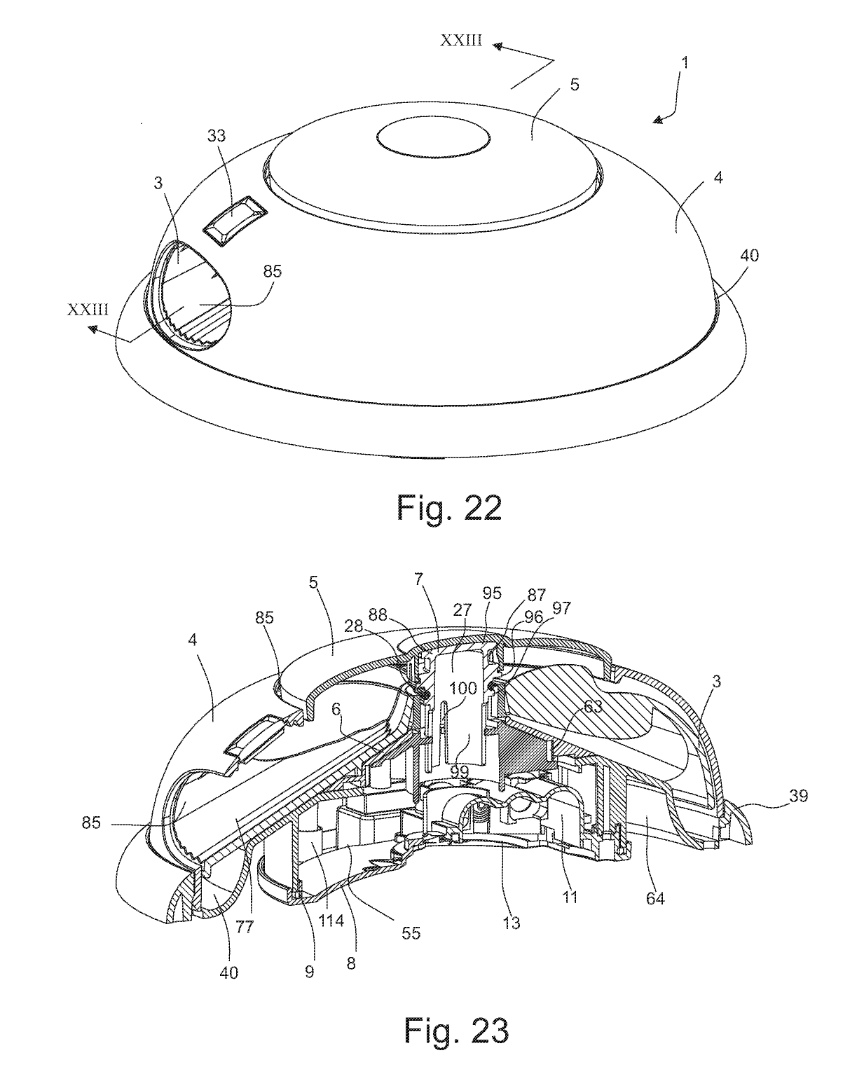

FIG. 22 shows the food dispenser in assembled state,

FIG. 23 is a sectional view taken along line XXIII-XXIII in FIG. 22 and seen inside the food dispenser,

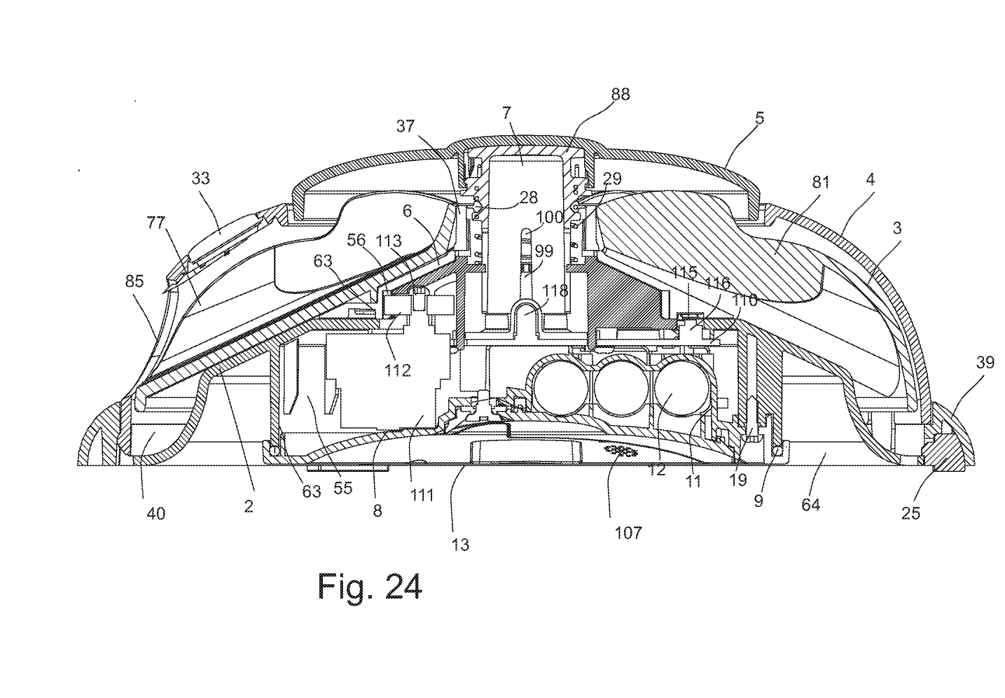

FIG. 24 is another sectional view of the assembled food dispenser, and

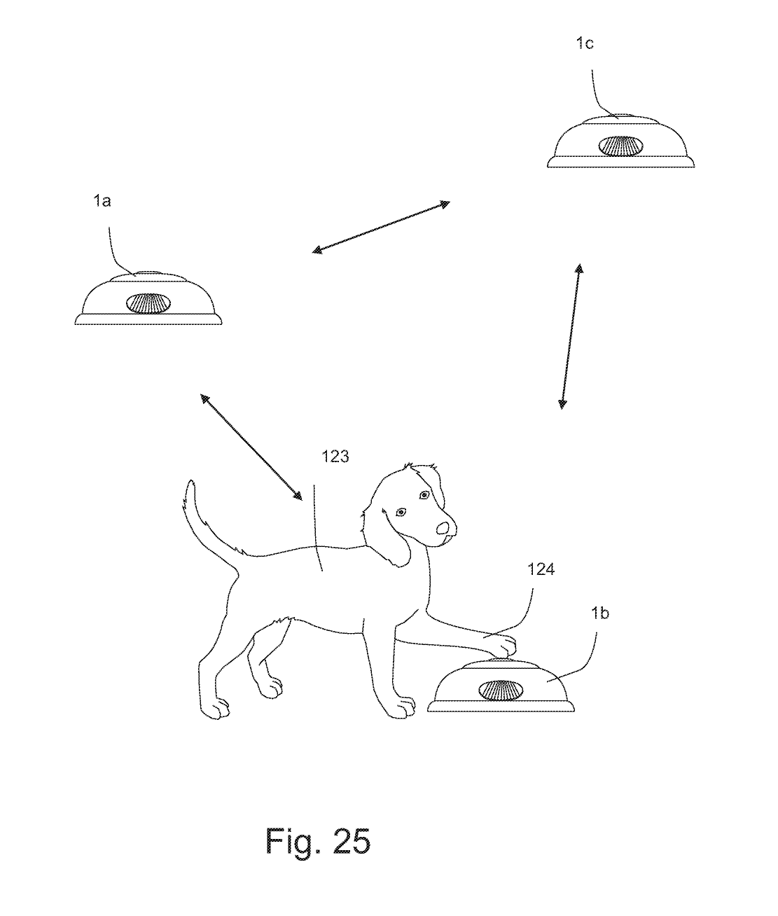

FIG. 25 shows several food dispensers in a motivating and exercising feeding setup.

The exploded views of FIGS. 1 and 2 provide an overview of the basic components of an embodiment of a food dispenser 1 seen from different angles.

All main components will be discussed in further details in relation to additional figures of each component, in relation to figures illustrating the food dispenser in assembled state, as well as by way of sections taken through the food dispenser 1 in its assembled state.

The main components of the food dispenser 1 are a base plate 2, a feeding bowl 3, a first lid part 4, a second lid part 5, a synchronization ring 6 for operative interaction with the feeding bowl 3 and the base plate 2 as part of a rotary mechanism, an elongated actuator 7 that is in operative engagement with the second lid part 5, a cover part 8 for covering a receptacle (not visible), which receptacle has its opening at a bottom face 16 of the base plate 2. The receptacle accommodates at least the electronic means 10 and a motor unit (not shown). The cover part 8 has a battery compartment 11 for batteries 12. The battery compartment 11 is operated from outside the food dispenser 1 and has a closure lid 13 designed with cavities 18 for holding the batteries 12 when the battery compartment 11 is closed. A first sealing ring 9 is inserted between the bottom face 16 and the cover part 8 to seal the food dispenser 1 and aid in protecting the components inside the receptacle from the environment. The cover part 8 is screwed together with the base plate 2 at the bottom face 16 using a suitable number of screws 19 inserted via a corresponding numbers of screw holes 20 in the cover part 8 to close the receptacle. The number of screws 19 and screw holes 20 can be any although only two are seen in FIG. 1. The cover part 8 provides a closed compartment for electric contacts to be activated by the actuator 7, electric on/off switches for turning on/off signaling means, such as a speaker or LED, or power switches, motor unit 111, microprocessor, transceivers of the wireless communication means, etc. as will be explained in more detail in the further figures. A second sealing ring 21, e.g. of water-proofed silicone, is provided between the closure lid 13 and the battery compartment 11 to ensure that humid or other matter does not unintentionally enters the battery compartment 11.

A switch cover 22 is to be mounted in a first hole 23 of a first socket 24 of cover part 8, so that an on/off switch (not shown) can be operated from outside the food dispenser 1 to switch on/off power. A plurality of feet 25, such as rubber ferrules, are distributed at the base face 16 of the base plate 2 to serve as anti-frictional means when the animal operates the food dispenser. Preferably the feet 25 are distributed circumferentially along the perimeter of the bottom face 16 of the base plate 2.

A coaxial antenna 26 and a transceiver (not shown) are provided to ensure wireless communication between several food dispensers 1 within wireless signal transmitting and signal receiving distance.

The elongated actuator 7 has an inner part 27 located through an O-ring 28, and a first spring 29 for spring-biased axial displacement. A recess or window opening 30 in the circumferential skirt 31 of the first lid part 4 serves for presenting a logo or sign 32, which logo pr sign 32 is protected by a window cover 33. The window cover 33 can e.g. be snapped-fit into the recess or window opening 30 to trap the logo or sign 32, or be glued or hot-welded together.

The main components are also seen in FIG. 2 and will be described in further detail with reference to individual figures.

FIG. 3 shows the base plate 2 in a perspective view oblique from above. The base plate 2 has an overall appearance of a tapering shell 17 in order to, on then one hand be able to fit inside the feeding bowl 3 and to serve for mounting the synchronization ring 6, and on the other hand be adapted for housing more or less of the rotary mechanism, the electronic components and the wireless communication means.

More specifically, the base plate 2 has a lower portion 34 extending via an intermediate portion 35 further into a top portion 36, which terminates into a central upright tubular connection piece 37 for passage of the inner part 27 of the actuator 7 to allow said inner part 27 to switch on/off contacts located in the receptacle. The lower part 34 of the base plate 2 is a support plate 38 with anti-sliding feet 25 on the base face 16. The lower part 34 includes support plate 38 with the base face 16 on one side, and on the opposite side the support plate 38 has a peripheral upright rim portion 39 that in assembled state of the food dispenser 1 surrounds the lower circumference of the feeding bowl 3. A circumferential waste groove or food collection groove 40 is delimited between an internal diameter 41 of the upright rim portion 39 and an external diameter 42 of a first tubular lower part 43 of the intermediate portion 35. The first tubular lower part 43 of the intermediate portion 35 extends into a first truncated cone part 44. The circumferential outer wall face 45 of the first truncated cone part 44 serves as an abutting sliding face for the feeding bowl 3 in assembled state of the food dispenser 1 during rotation of the feeding bowl 3. The upper surface 46 of the first truncated cone part 44 defines a plateau 47 on top of which the top portion 36 is located. The top portion 36 includes a second tubular part 48 having a smaller diameter than the plateau 47 to define a shoulder 49 on the plateau 47 for mounting an annular ring part 50 of the synchronization ring 6, which second tubular part 48 extends into a second truncated cone part 51 wherefrom the central upright connection piece 37 projects axially.

The outer annular part of the support plate 38 that includes the bottom of the waste groove or food collection groove 40 has annularly distributed first securing holes 52 allowing the food dispenser 1 to be anchored, e.g. using screws via the securing holes to some kind of base, such as the floor. If the first securing holes 52 are left free they advantageously also can serve as drainage holes. The upright rim portion 39 and/or waste groove or food collection groove 40 have through-holes 53 for easier mounting, detaching and/or replacing the feet 25, thus to be able to easily push the feet 25 out of the support plate 38. Second securing holes 54 in the shoulder 49 serves to fix a motor unit (not shown) inside the receptacle 55 seen better in the bottom view of FIG. 4 of the base plate 2. The shoulder 49 has a plate spring opening 55 for a protruding plate spring (not shown) that mechanically controls the angle the rotary mechanism can rotate the feeding bowl by its engagement with the synchronization ring 6, optionally upon input from a microprocessor and/or in response to switching on/off a contact upon depression of the plate spring e.g. when the animal activates the actuator. The protruding plate spring engages with stops on the synchronization ring 6, as will be seen in the below FIGS. 6 and 7 of the synchronization ring 6.

Further, the second tubular part 48 of the top portion 36 has a drive hole 56 that allows a second drive means (not shown) associated with the base plate 2 to protrude. The second drive means can e.g. be a first toothed gear wheel in transmission with another second toothed wheel on a motor shaft of a motor unit.

The base plate 2 has annularly distributed peripheral second engagement means 57 located in the upright rim portion 39 of the lower part 34 of the base plate 2. Optionally the peripheral second engagement means 57 extends into the waste collection groove 40 too, to expose a larger area for engaging peripheral first engagement means 58 along a free bottom edge 59 of the first lid part 4, as seen in FIG. 2. In the present embodiment the food dispenser 1 has seven female peripheral first engagement means 58 and seven male second peripheral engagement means 57 that lock the first lid part 4 to the base plate 2 by snap-coupling. In the present embodiment the female first peripheral engagement means 58 are substantially axially protruding webs with a hook that snaps together with second male peripheral engagement means 57 in form of holes.

The circumferential wall 60 of the tubular connection piece 37 has two opposite axially extending flexing leaf springs 61 with respective radial outwards facing noses 62 below which the synchronization ring 6 in held in position on the base plate 2, so that a first drive means of the synchronization ring 6, such as a toothed wheel or belt 63, is in operative driving contact with a second drive means, such as a gear wheel that protrudes from the drive hole 56 of the second tubular part 48 of the top portion 36 of the base plate 2 to rotate in the radial plane of the base plate 2.

FIG. 4 shows the base plate 2 from the bottom face 16 of the base plate 2. The circumferential shell 17 delimits a hollow interior divided by an interior cylindrical wall 63 into the receptacle 55 surrounded by a circumferential channel 64 that facilitates grasping of the food dispenser 1 by providing a suitable gripping cavity. The receptacle 55 houses a plurality of reinforcing ribs 65, spacers 66 for keeping distance to the cover part 8, and mounts 67, for e.g. a double sided printed circuit board (PCB) that mechanically supports and electrically connects the electronic components, including the microprocessor, the antenna, the transceiver, the control unit, the signaling means etc.

FIG. 5 is an axial sectional view taken along line V-V in FIG. 3 to illustrate the receptacle 55 inside the step-pyramidal shell 17. The tubular connection piece 37 is in open communication with the interior space 68 of the receptacle 55, and thus with components situated inside the receptacle 55.

FIG. 6 is a perspective view of the slightly tapering dish-shaped synchronization ring 6 seen oblique from above. The synchronization ring 6 has an annular ring part 50, delimiting a ring opening 69 for passage of the actuator 7. An exterior face 70 of the synchronization ring 6 constitutes an upper engagement face 70 provided with a third engagement means 71 in form of indents or cavities 71 adapted to interlock and/or engage fourth engagement means 72 in form of projections or steps 72 on the interior part 73 of a tapering main body 74 of the feeding bowl 3, as shown in the subsequent FIGS. 10 and 11.

As seen better in the top view of FIG. 8 the synchronization ring 6 has seven indents or cavities 71.

As seen better in the bottom views of FIGS. 7 and 9 the interior face 75 opposite the exterior face 70 is the lower drive face 75 provided with a first drive means 63, in the present case a toothed belt 63. The first drive means 63 are encircled by a ring of seven stops 76 for in turn snapping over a plate spring protruding axially upwards through the plate spring opening 55 of the base plate 2 each time the feeding bowl 3 is rotated 7/360° to dispense food from a respective food compartment 77 of the feeding bowl 3 shown in FIGS. 10 and 11.

Similarly to the base plate 2 and the synchronization ring 6 the feeding bowl 3 are tapered so that said components can be stacked in operative engagement with each other.

The feeding bowl 3 has a tapering main body 74, a feeding bowl base 78, and a central opening 79 in axial distance from the feeding bowl base 78, which central opening 79 allows passage of the inner part 27 of the actuator 7 with an enlarged actuator head protruding from the opening. The tapering main body 74 has an interior part 73 configured with fourth engagement means in form of projections 72 that engage the third engagement means 71 of the synchronization ring 6 for rotation. An exterior part 80 of the feeding bowl 3 is configured with seven angularly spaced-apart partition walls 81 for delimiting a plurality of seven, angularly, spaced-apart, inclined food compartments 77, configured as chutes 82 with guide grooves 83 diverging in fan-shape 84 from the central opening 79 towards the feeding bowl base 78.

FIG. 12 is a perspective view of the first lid part 4, and FIG. 13 shows the same in a perspective view from the bottom inside the first lid part 4.

The circumferential skirt 31 of the first lid part 4 has an outlet opening 85 for delivery of a food portion to the animal subsequent to actuation of the actuator 7. A food compartment is rotated in front of this outlet opening 85 and food slides by virtue of gravity on the chute 82 and out via the outlet opening 85 to be taken by the animal. Food is charged to the food compartment 77 of the feeding bowl 3 via a central charging opening 86 once the first lid part 4 is coupled to the base plate 2.

The elongated actuator 7 is seen in FIG. 15 aligned axially with the second lid part 5. The actuator 7 has an inner part 27 to be mounted in the tubular connection piece 37 of the base plate 2 so that a free manipulation end 87 with an actuator head 88 can engage a clamp 89 on the interior face 90 of the second lid part 5, a seen in FIG. 14, when said second lid part 5 is mounted to cover the central charging opening 86 of the first lid part 4. At the exterior face 91 of the second lid part 5 the clamp 89 for connecting the actuator head 88 to the second lid part 5 may have a transparent or light-penetrateable top cover 92 that allows light to pass through, e.g. an outwards curving transparent plastic cover. Optionally the entire second lid part 5 is transparent or light-pentrateable. Together the actuator head 88, the top cover 92 and the second lid part 5 constitute a combined button, which the animal pushes, presses on, or otherwise manipulates to activate a contact for the motor unit of the rotary mechanism and make this rotary mechanism to work to dispense a food portion. The radial skirt 93 surrounding the clamp 89 can move slightly up and down in relation to the first lid part 4, which may be sufficient for activation of the actuator 7 even though the actuator 7 itself is not hit. The large surface of the radial skirt 93 of the second lid part 5 provides an expedient long arm for force application to said actuator 7 that makes it easy for the animal to be successful to activate the food dispenser 1, and thus to dispense a food portion by rotating the feeding bowl 3. In the present embodiment the clamp 89 consists of a plurality of flexible fingers 94 arranged in a ring to fit and snap over the actuator head 88. The flexible fingers 94 are oriented radially around the top cover 92 to protrude axially therefrom.

The enlarged scale views of FIGS. 16 and 17 shows more specifically the structure of the actuator 7. The actuator head 88 extends via a first coupling flange 95 for coupling with the flexible fingers 94 of the clamp 89 of the second lid part 5 via a tubular piece into a second flange 96 having a larger diameter than the internal diameter of the tubular connection piece 37 of the base plate 2, so as to allow the second flange 96 to abut the free end of said tubular connection piece 37. The tubular connection piece 37 may have an internal thread (not shown) to couple with an external thread 97 of the inner part 27 of the actuator 7 below the second flange 96. Other means than threads may be used alternatively for coupling the actuator 7 firmly inside the tubular connection piece 37. The inner part 27 is in the present embodiment a hollow tubular part extending from the second flange 96 towards an actuator end 98 for activating electric contacts inside the receptacle 55 of the base plate 2. In the present embodiment the inner part 27 is, by means of slots 100, divided into four axially extending legs 99 to confer suitable radial flexibility to the inner part 27 that facilitates easy mounting inside the tubular connection piece 37. Each leg 99 has a radially protruding bead 101 that engages the inner wall of the tubular connection piece 37 and/or holds the spring 29 in axial position.

FIGS. 18 and 19 show an embodiment of the cover part 8. Emphasis is made that this specific design is only exemplary. The design and topography of the upper side 102 of the cover part 8 depends mainly on the arrangement of the components that are located inside the receptacle, and the design and topography of the lower side 103 depends on the number and choice of switches, batteries, microphones, etc, that shall be accessible from outside the food dispenser 1. Thus, any design of cover plate 8 suited to cover the receptacle 55 of the base plate 2 is within the scope of the present invention.

The first socket 24 has a first hole 23 on the upper side 102 for enabling a power supply contact located on a PCB (not shown) inside the receptacle 55 to be operated via an on/off power switch accessible from the lower side 103. Similarly, a second socket 104 has a second hole for making a contact for the signaling means located on a PCB (not shown) inside the receptacle 55 to be operated via an on/off switch (not shown) accessible from the lower side 103. A microphone 105 consists of a tube 106 that ends in a plurality of adjacent holes 107 in the cover part 8 base plate 108 to allow a sound signal issued by the signaling means on a PCB (not shown) to be perceived by the animal. An annular groove 109 serves for receiving the first sealing ring 9 to ensure seal-tight connection between cover part 8 and base plate 2.

FIGS. 20 and 21 are perspective views of a PCB 110 in conjunction with a motor unit 111, signaling means, and means for wireless communication 26 seen oblique from above. The PCB 110 is shown without the actual electric circuit of the board. Ordinary electronic components known to the person skilled in the art are not shown.

A second drive means is a second toothed wheel 112 on a rotary shaft 113 of the motor unit 111. As seen better in FIG. 23, in the assembled state of the food dispenser 1 the second toothed wheel 112 protrudes out of the drive hole 56 in the base plate 2 for engaging the first drive means 63 of the synchronization ring 6 to rotate the feeding bowl 3 in response to actuation of the actuator 7 by pushing the second lid part 5 so that the motor unit 11 is switched on. A sound issuing means 114 of the signaling means are arranged above the microphone 105 in the assembled state of the food dispenser 1.

A plate spring 115 protrudes upright from the PCB 110 and out of the plate spring opening 55 in the base plate 2 when the PCB is mounted in the bottom of the receptacle 55, thus to the base plate 2. The plate spring 115 is pressed down when the synchronization ring 6 rotates into electrical contact with angular control switch 116 of the rotary mechanism. When the feeding bowl 3 starts to rotate an angle corresponding to a food compartment the plate spring 115 will be pressed down against the control switch 116 to close an electric circuit controlling said degree of angular rotation. At the end of this predetermined rotation the electric contact between the plate spring 115 and the control switch 116 is terminated. The plate spring 115 may e.g. slide against an annular step 117 tapering in the rotation direction between to angularly spaced apart stops 76, so as to release spring force and disrupt contact. This procedure is repeated each time the actuator 7 is operated until the control unit determines that all food compartments 77 are now empty.

A spacer disk 118, such as a rubber disk 118, and guide tabs 119 serve to position the PCB 110 correctly inside the receptacle 55 of the base plate 2.

A transceiver 120 with an antenna 26 provides for wireless communication between several food dispensers 1. The wireless communication system has a separate switch and contact 121, and the overall control of the computer program for operating the food dispenser 1 is done by suitable programmed microprocessor 122.

FIG. 22 shows the food dispenser 1 in an assembled state, in dispensing position where a food compartment 77 is located aligned with the outlet opening 85 of the second lid part 4.

How the different individual structural components of the food dispenser 1 are interconnected and positioned in relation to each other becomes are seen in the perspective sectional fragmentary view of FIG. 23 taken along line XXII-XXII in FIG. 22 and seen inside the food dispenser 1 and from the sectional view of FIG. 24. For illustrative purposes PCB and electronics are left out in FIG. 23. The sectional views illustrate further how the various main components are coupled together as already discusses in detail in relation to the previous figures.

FIG. 25 shows three food dispensers 1a,1b,1c in the method according to the present invention. The food dispensers 1a,1b,1c are all charged with food in respective six food compartments 77, and arranged in a motivating and exercising feeding setup within wireless communication.

A first food dispenser 1a, a second food dispenser 1b, and a third food dispenser 1c are arranged within wireless communication distance. All three has power switched on, and the signaling means and the wireless communication means are on. The operator starts the first food dispenser 1a to issue a sound signal via the microphone 105 and/or light signal via the second lid 5. The sound signal and/or light signal attracts the attention of a dog 123 to use its paw 124 to stop the noise or light, however in its attempt to deactivate the issued signals the dog 123 manipulates the actuator head 88 so that the motor unit becomes activated and rotates the feeding bowl 3 an angle corresponding to a food compartment to discharge food from a first of six charged food compartments 77. At the same time the wireless communication means of the first food dispenser 1a has identified the subsequent food dispenser 1 of the setup within wireless communication, and transmitted a control signal to the second food dispenser 2b that triggers this subsequent second food dispenser 1b to issue a sound signal and/or light signal which the dog 123 now knows better how it get food from a food dispenser 1a. So the dog runs towards the second food dispenser 1b and performs the same action as with the first food dispenser 1b. These steps are repeated with the third food dispenser and until all food compartments are empty, as indicated by double arrows in FIG. 25. In the method according to the food dispenser the food dispensers are placed as desired. Placement may e.g. be random, specialized, be in different or same rooms, and the control unit be programmed to identify the next food dispenser closest to the previous food dispenser, taking accounts of which food dispenser was used last, and counting the number of rotation a certain food dispenser has rotated.

Alternatively, instead that actuation of the actuator triggers activation of the signaling means of the next food dispenser, the signaling means of the second food dispenser and third food dispenser can be timed, so that the sound signal or light signal is issued after a certain time irrespective of whether or not the dog has been successful at the first dispenser 1a.

Eventually the dog will get acquainted with this way of getting food and having fun running between food dispensers to eat. Dog love to play and to challenge the dog further food dispensers can be more or less hidden.

The way the actuator activates the various means by closing contact on an electric circuit, should not be construed as limiting the present invention. Mechanical means and optic sensors are also within the scope of the present invention.

Any rotary means, signaling means, and wireless communication means suited for performing the actions described above are within the scope of the present invention.

Only humans can get the second lid part off because any of the second lid part and the first lid part needs to be operated by fingers from below.

1.-29. (canceled)

30. A method of exercising and/or training an animal which comprises the steps of:
a) providing a plurality of food dispensers (1) charged with one or more food items, which plurality comprises a first food dispenser (1) and at least one second food dispenser (1) with each food dispenser comprising:
a base plate (2),
a feeding bowl (3) with a plurality of food compartments (77),
a rotary mechanism for rotating the feeding bowl (3) in relation to the base plate (2), and
a lid (4,5) that covers at least the majority of the food compartments (77) and has an outlet opening (85), the lid comprising a first lid part (4) in form of an outer annular skirt detachable connected to the base plate (2) and defining a central charging opening (85), and a second lid part (5) for detachably covering the charging opening (85),
an actuator (7) having a free manipulation end (87) in operative contact with the second lid part (5), which actuator (7) upon actuation activates at least the rotary mechanism to rotate the feeding bowl (3) to place a food compartment (77) in front of the outlet opening (86) of the first lid part (4); and
signaling means for emitting an audible or visual signal,
with each food dispenser in predetermined wireless communication distance from each other, which plurality of food dispensers (1) has respective control units programmed to link the plurality of food dispensers (1) to each other in a predetermined execution pattern mode,
b) switching on the power, the wireless communication system, and the signaling means of the food dispensers (1) of the plurality,
c) starting the first food dispenser (1) of the plurality of food dispensers (1),
d) the signaling means of the first food dispenser (1) of the plurality of food dispensers (1) issues a signal to the animal guiding the animal to the first food dispenser (1),
e) the signal causes the animal to actuate the manipulation end (87) of the actuator (7) to operate the rotary mechanism to rotate the feeding bowl (3) an angle of 360°/n, wherein n is the number of food compartments (77), to dispense at least one food item via the outlet opening (85),
f) subsequent to the dispensing of step f) the wireless communication system activates the signaling means of the next food dispenser (1) of the plurality of food dispensers (1) to issue a signal to the animal guiding the animal to said next food dispenser (1), and
g) repeating steps e)-f).

31. A method according to claim 30, wherein the feeding bowl (3) of a food dispenser (1) of the plurality of food dispensers (1) is rotated n−1 angular steps.

32. A method according to claim 30, wherein the number of food dispensers (1) in Han the plurality of food dispensers (1) is at least two.

33. A method according to claim 30, wherein the number of food dispensers (1) in the plurality of food dispensers (1) is equal to or less than fifty.

34. A method according to claim 30, wherein the plurality of food dispensers (1) is operated in random order or sequentially.

35. A method according to claim 30, wherein the plurality of food dispensers (1) further comprises at least one food dispenser (1) that is not in wireless communication with the remaining food dispensers (1).

36.-40. (canceled)

41. The method of claim 30 wherein the animal is a dog or cat.

42. A method of exercising and/or training an animal which comprises the steps of:
a) providing a plurality of food dispensers charged with one or more food items, including a first food dispenser and at least one second food dispenser, with each food dispenser comprising a feeding bowl having a plurality of food compartments, a rotary mechanism for rotating the feeding bowl, a lid that covers at least the majority of the food compartments and has an outlet opening, with the lid comprising a first lid part in form of an outer annular skirt detachable connected to the base plate and defining a central charging opening, a second lid part for detachably covering the charging opening, signaling means for emitting an audible or visual signal, and an actuator having a free manipulation end and in operative contact with the second lid part, which actuator upon actuation activates at least the rotary mechanism to rotate the feeding bowl to place a food compartment in front of the outlet opening of the first lid part, and with the food dispensers being in a predetermined wireless communication distance from each other, which plurality of food dispensers has respective control units programmed to link the plurality of food dispensers to each other in a predetermined execution pattern mode, and
b) providing a signal from the signaling means to the animal to indicate that food may be dispensed from the food dispenser and to guide the animal to the first food dispenser, wherein the signal causes the animal to actuate the manipulation end of the actuator to cause the rotary mechanism to dispense at least one food item via the outlet opening.

43. A method according to claim 42, wherein, subsequent to the dispensing, the wireless communication system activates the signaling means of the next food dispenser of the plurality of food dispensers to issue a signal to the animal guiding the animal to the next food dispenser.

44. A method according to claim 43, wherein the providing and activating steps are repeated.

45. A method according to claim 42, wherein the feeding bowl of the food dispenser of the plurality of food dispensers is rotated.

46. A method according to claim 41, wherein the number of food dispensers in the plurality of food dispensers is at least two.

47. A method according to claim 41, wherein the number of food dispensers in the plurality of food dispensers is equal to or less than fifty.

48. A method according to claim 41, wherein the plurality of food dispensers is operated in random order or sequentially.

49. A method according to claim 41, wherein the plurality of food dispensers further comprises at least one food dispenser that is not in wireless communication with the remaining food dispensers.

50. The method of claim 41 wherein the animal is a dog or cat.
